(19) United States
(12) Patent Application Publication
(10) Pub. No.: US 2025/0276628 A1
(43) Pub. Date: Sep. 4, 2025

(54) VEHICLE SEAT

(71) Applicants: NHK SPRING CO., LTD., Yokohama-shi (JP); SUBARU CORPORATION, Tokyo (JP)

(72) Inventors: Jun TAKEDA, Yokohama-shi (JP); Kazuyoshi NISHIGAKI, Yokohama-shi (JP); Masato FUKUSHIMA, Tokyo (JP)

(21) Appl. No.: 19/057,651

(22) Filed: Feb. 19, 2025

(30) Foreign Application Priority Data
Feb. 29, 2024 (JP) 2024-030577

(51) Int. Cl. B60N 2/90; B60N 2/70

(52) U.S. Cl. CPC B60N 2/90; B60N 2/70

(57) ABSTRACT

A vehicle seat includes a seat cushion main body portion that configures a portion of a seat cushion that supports buttocks of a seated occupant from a seat lower side, and an extension portion that configures another portion of the seat cushion and that is provided at a front end side of the seat cushion main body portion. A length of the seat cushion in a seat front-rear direction is adjusted due to the extension portion being displaced in the seat front-rear direction. A weight is provided at an interior of the extension portion. The weight is provided at the interior of the extension portion in a state of being relatively displaceable in an up-down direction with respect to the extension portion.

### CROSS-REFERENCE TO RELATED APPLICATION

This application is based on and claims priority under 35 USC 119 from Japanese Patent Application No. 2024-030577 filed on Feb. 29, 2024, the disclosure of which is incorporated by reference herein.

### BACKGROUND

### Technical Field

The present disclosure relates to a vehicle seat.

### Related Art

Japanese Patent Application Laid-Open (JP-A) No. 2023-64925 discloses a vehicle seat including a cushion length varying function that enables a cushion length of a seat cushion that supports buttocks of a seated occupant to be varied. The seat cushion described in this document includes a retracting member that is bridged between a sewing margin portion of a cushion cover and a cushion rear portion, and a pushing member that is provided at a cushion front portion. The pushing member applies a pushing force to the retracting member due to an operation in which the cushion front portion approaches the cushion rear portion, such that the cushion cover is retracted into a gap between the cushion front portion and the cushion rear portion via the retracting member. This enables the cushion cover to appropriately follow changes in the cushion length.

In this regard, although the configuration described in Japanese Patent Application Laid-Open (JP-A) No. 2023-64925 is a configuration that is useful from the perspective of enabling the cushion cover to appropriately follow changes in the cushion length, it does not take into consideration suppression of the occurrence of abnormal noise in the seat cushion due to vibration of a vehicle.

### SUMMARY

The present disclosure obtains a vehicle seat that is capable of suppressing the occurrence of abnormal noise in a seat cushion due to vibration of a vehicle.

A vehicle seat of a first aspect includes: a seat cushion main body portion that configures a portion of a seat cushion that supports buttocks of a seated occupant from a seat lower side; an extension portion that configures another portion of the seat cushion and that is provided at a front end side of the seat cushion main body portion, a length of the seat cushion in a seat front-rear direction being adjusted due to the extension portion being displaced in the seat front-rear direction; and a weight that is provided at an interior of the extension portion in a state of being relatively displaceable in an up-down direction with respect to the extension portion.

In the vehicle seat of the first aspect, the buttocks of the seated occupant are supported by the seat cushion from the seat lower side. The seat cushion includes the seat cushion main body portion and the extension portion that is provided at the front end side of the seat cushion main body portion. The length of the seat cushion in the seat front-rear direction is adjusted due the extension portion being displaced in the seat front-rear direction. The weight is provided at the interior of the extension portion. The weight is relatively displaceable in the up-down direction with respect to the extension portion. Due to this configuration, when vibration of the vehicle is transmitted to the extension portion, the weight moves independently of the extension portion, and functions like a dynamic damper. Consequently, vibration of the extension portion with respect to the seat cushion main body portion is suppressed. Thus, in the vehicle seat of the first aspect, the occurrence of abnormal noise in the seat cushion due to vibration of the vehicle can be suppressed.

A vehicle seat of a second aspect is the vehicle seat of the first aspect, wherein at least one of an inner surface of a space in which the weight is provided at the extension portion or an outer surface of the weight is covered by a cushioning member that is capable of cushioning an impact.

In the vehicle seat of the second aspect, at least one of the inner surface of the space in which the weight is provided at the extension portion or the outer surface of the weight is covered by a cushioning member that is capable of cushioning an impact. Due to this configuration, direct contact between the inner surface of the space in which the weight is provided at the extension portion and the outer surface of the weight is prevented or suppressed. Consequently, the occurrence of abnormal noise due to direct contact between the inner surface of the space in which the weight is provided at the extension portion and the outer surface of the weight can be prevented or suppressed.

A vehicle seat of a third aspect is the vehicle seat of the first aspect or the second aspect, wherein: the extension portion is configured to include an extension portion main body having a weight arrangement recess that forms a space in which the weight is arranged and that is open at a seat lower side thereof, and a closure member that closes an open end side of the weight arrangement recess in a state of being attached to a seat lower side of the extension portion main body; and the closure member is formed using a member that is formed in a sheet shape and that is capable of deflection deformation in a thickness direction thereof.

In the vehicle seat of the third aspect, the weight is arranged within the weight arrangement recess of the extension portion main body. Further, the closure member is attached to the seat lower side of the extension portion main body. Consequently, the open end side of the weight arrangement recess is closed by the closure member. The weight is supported from the seat lower side by the closure member. Furthermore, the closure member is formed using a member that is formed in a sheet shape and that is capable of deflection deformation in a thickness direction thereof. Due to this configuration, movement of the weight in the seat up-down direction can be attenuated by the closure member.

A vehicle seat of a fourth aspect is the vehicle seat of the third aspect, wherein an opening through which the weight, which has been housed within the weight arrangement recess, is visible is formed at the closure member.

In the vehicle seat of the fourth aspect, the opening through which the weight, which has been housed within the weight arrangement recess, is visible is formed at the closure member. Due to this configuration, in an assembly process of the extension portion, it can be confirmed, through the opening formed at the closure member, whether or not insertion of the weight into the weight arrangement recess has been forgotten.

The vehicle seat according to the present disclosure has an effect in that the occurrence of abnormal noise in a seat cushion due to vibration of a vehicle can be suppressed.

### BRIEF DESCRIPTION OF THE DRAWINGS

An exemplary embodiment of the present disclosure will be described in detail based on the following figures, wherein:

FIG. 1 is a side view schematically illustrating a vehicle seat of the present exemplary embodiment;

FIG. 2 is an exploded perspective view illustrating an extension portion of a seat cushion in an exploded manner; and

FIG. 3 is a cross-sectional view illustrating the extension portion of the seat cushion in a cross-section taken along a front-rear direction and an up-down direction.

### DETAILED DESCRIPTION

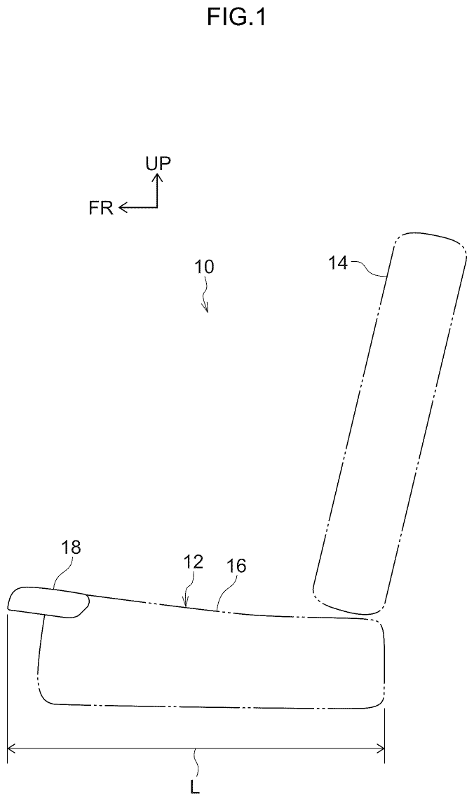

A vehicle seat 10 according to an exemplary embodiment of the present disclosure will be explained, with reference to FIGS. 1 to 3. It should be noted that, in the drawings, arrow FR indicates a seat front side, arrow UP indicates a seat upper side, arrow LH indicates a seat width direction left side, and arrow RH indicates a seat width direction right side, respectively. Further, unless specifically stated otherwise, in the following explanation, reference to front-rear, up-down, and left-right directions refers to front and rear in a seat front-rear direction, up and down in a seat up-down direction, and left and right in a seat width direction.

As illustrated in FIG. 1, the vehicle seat 10 of the present exemplary embodiment includes a seat cushion 12 that supports buttocks of a seated occupant from a lower side, and a seatback 14 that supports a back of the seated occupant from a rear side. The seat cushion 12 includes a seat cushion main body portion 16, an extension portion 18 supported by the seat cushion main body portion 16 at a front end side of the seat cushion main body portion 16, and a drive section (driver), which is not illustrated in the drawings, that displaces the extension portion 18 in the front-rear direction with respect to the seat cushion main body portion 16. A length L of the seat cushion 12 in the front-rear direction is adjusted due to the extension portion 18 being displaced in the front-rear direction by the drive section.

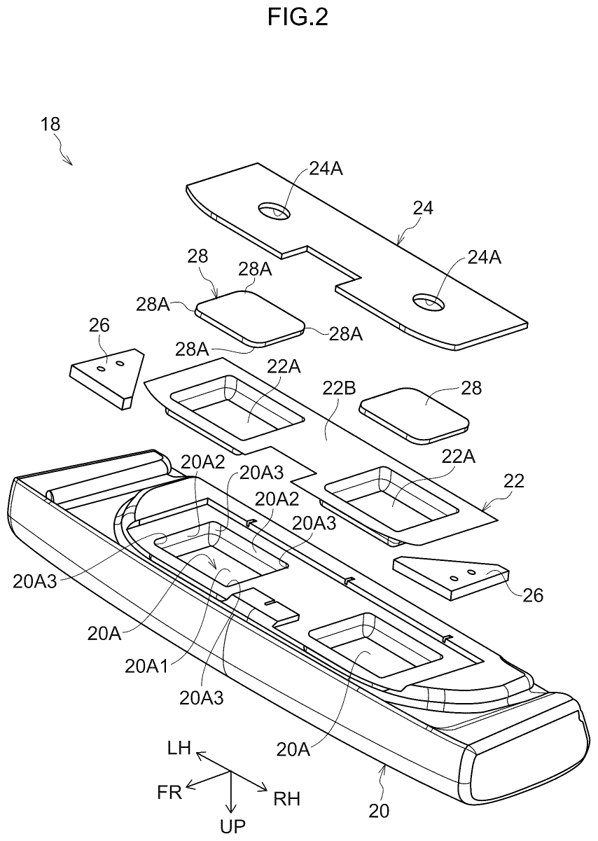

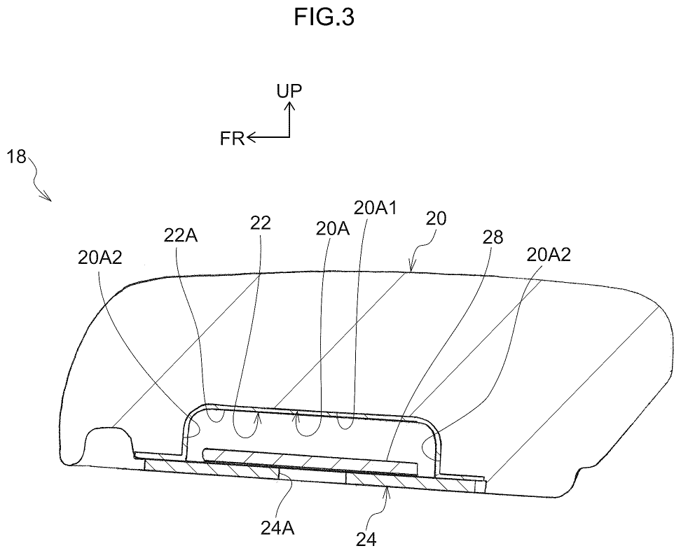

As illustrated in FIGS. 2 and 3, the extension portion 18 is configured to include an extension portion main body 20 that is formed in a block shape, a cushioning member 22 that is fixed to the extension portion main body 20, a closure member 24 that is fixed to the extension portion main body 20 via the cushioning member 22, and a pair of connection plates 26 that are fixed to the extension portion main body 20.

The extension portion main body 20 is formed in a rectangular block shape with a longitudinal direction thereof being along the left-right direction, using urethane or the like as an example. A range of a surface of the extension portion main body 20 that is visible to an occupant of the vehicle is covered by a skin, which is not illustrated in the drawings. A pair of weight arrangement recesses 20A that form spaces in which a pair of weights 28, which will be described later, are respectively arranged are formed at a lower portion of the extension portion main body 20. These weight arrangement recesses 20A each have the same shape and size as each other, each have a shape such that a seat lower side thereof is open, and are each formed in a quadrangular shape as viewed from a lower side. Further, a boundary portion between a bottom face 20A1 of each weight arrangement recess 20A and side faces 20A2 that stand up toward the lower side from a periphery of the bottom face 20A1 has a shape that is gently curved. Furthermore, four corners 20A3 of each weight arrangement recess 20A also have shapes that are gently curved.

The cushioning member 22 is formed using, for example, a thin cloth or felt that is capable of cushioning an impact. The cushioning member 22 includes a pair of recess inner covering portions 22A that respectively cover inner surfaces of the pair of weight arrangement recesses 20A in the extension portion main body 20, and an end face covering portion 22B that covers end faces at open end sides of the pair of weight arrangement recesses 20A in the extension portion main body 20. It should be noted that the cushioning member 22 may be fixed to the extension portion main body 20 during molding of the extension portion main body 20, or may be fixed to the extension portion main body 20 after molding of the extension portion main body 20.

As an example, the closure member 24 is thicker than the cushioning member 22, and is formed using a sheet-shaped felt that is capable of deflection deformation in a thickness direction thereof. An outer shape of the closure member 24 when viewed from the lower side is formed in a shape corresponding to an outer shape of the end face covering portion 22B of the cushioning member 22. The closure member 24 is joined to the end face covering portion 22B of the cushioning member 22, which is fixed to the extension portion main body 20. Consequently, the closure member 24 is fixed to the extension portion main body 20 via the cushioning member 22. Further, in a state in which the closure member 24 is fixed to the extension portion main body 20, the open end sides of the pair of weight arrangement recesses 20A are closed by the closure member 24. Consequently, spaces in which a pair of weights 28, which will be described later, are arranged are formed between the pair of weight arrangement recesses 20A and the closure member 24. Furthermore, circular openings 24A are respectively formed at front-rear and left-right direction center portions of respective portions of the closure member 24 that close the open end sides of the pair of weight arrangement recesses 20A.

The pair of connection plates 26 are each formed in a triangular shape as viewed from the lower side. The pair of connection plates 26 are respectively fixed to both left and right direction end portions of a lower portion of the extension portion main body 20. The pair of connection plates 26 are respectively connected to a pair of support members that extend from a seat cushion main body portion 16 side.

The pair of weights 28 are provided between the extension portion main body 20 (the cushioning member 22) and the closure member 24. The pair of weights 28 are formed so as to have a determined weight, using a steel material, lead, or the like. It should be noted that, in the present exemplary embodiment, shapes, sizes, and weights of the pair of weights 28 are set to be the same shape, size, and weight as each other. Further, the weights 28 of the present exemplary embodiment are each formed in a plate shape with a thickness direction thereof being along the up-down direction, and are each formed in a quadrangular shape as viewed from the up-down direction. Furthermore, four corners 28A of each weight 28 have shapes that are gently curved. One of the pair of weights 28 explained above is arranged within a space formed between one weight arrangement recess 20A formed at the extension portion main body 20 and the closure member 24. Further, the other of the pair of weights 28 is arranged within a space formed between the other weight arrangement recess 20A formed at the extension portion main body 20 and the closure member 24.

As illustrated in FIG. 3, in a state in which the weights 28 are arranged within the spaces formed between the weight arrangement recesses 20A and the closure member 24, there is some clearance between the weights 28 and the side faces 20A2 of the weight arrangement recesses 20A (the recess inner covering portions 22A of the cushioning member 22) in the front-rear and left-right directions. Further, in a state in which the weights 28 are arranged within the spaces formed between the weight arrangement recesses 20A and the closure member 24, there is a clearance of approximately three to four times a thickness of the weights 28 in the up-down direction between the weights 28 and the bottom faces 20A1 of the weight arrangement recesses 20A (the recess inner covering portions 22A of the cushioning member 22).

### Operation and Advantageous Effects of the Present Exemplary Embodiment

Next, operation and advantageous effects of the present exemplary embodiment will be explained.

As illustrated in FIGS. 1 to 3, in the vehicle seat 10 of the present exemplary embodiment explained above, the buttocks of the seated occupant are supported from the seat lower side by the seat cushion 12, and the back of the seated occupant is supported from the rear side by the seatback 14. In this regard, the seat cushion 12 includes the seat cushion main body portion 16, and the extension portion 18 provided at the front end side of the seat cushion main body portion 16. The length L of the seat cushion 12 in the front-rear direction is adjusted due to the extension portion 18 being displaced in the front-rear direction by the drive section.

The pair of weights 28 are provided at an interior of the extension portion 18. The pair of weights 28 are configured to be relatively displaceable in the up-down direction with respect to the extension portion 18. Due to this configuration, when vibration of the vehicle is transmitted to the extension portion 18, the pair of weights 28 move independently of the extension portion 18, and function like a dynamic damper. Consequently, vibration of the extension portion 18 with respect to the seat cushion main body portion 16 is suppressed. Thus, in the vehicle seat 10 of the present exemplary embodiment, the occurrence of abnormal noise in the seat cushion 12 due to vibration of the vehicle can be suppressed.

Further, in the present exemplary embodiment, the inner surfaces of the pair of weight arrangement recesses 20A, which form the spaces in which the pair of weights 28 are respectively arranged, are covered by the pair of recess inner covering portions 22A of the cushioning member 22. Due to this configuration, direct contact between the inner surfaces of the pair of weight arrangement recesses 20A and outer surfaces of the pair of weights 28 is prevented or suppressed. Consequently, the occurrence of abnormal noise due to direct contact between the inner surfaces of the pair of weight arrangement recesses 20A and the outer surfaces of the pair of weights 28 can be prevented or suppressed.

Furthermore, in the present exemplary embodiment, a configuration is provided in which the pair of weights 28 are supported from the lower side by the closure member 24. The closure member 24 is formed using a felt that is capable of deflection deformation in the up-down direction, which is thickness direction thereof. Due to this configuration, movement of the pair of weights 28 in the up-down direction can be attenuated by the closure member 24.

Further, in the present exemplary embodiment, the pair of openings 24A are formed at the closure member 24. Due to this configuration, in an assembly process of the extension portion 18, it can be confirmed, through the pair of openings 24A formed at the closure member 24, whether or not insertion of the pair of weights 28 into the pair of weight arrangement recesses 20A has been forgotten.

It should be noted that, although an example in which the pair of openings 24A are formed at the closure member 24 has been explained in the present exemplary embodiment, the present disclosure is not limited thereto. Whether or not the openings 24A are formed at the closure member 24 as described above may be appropriately determined in consideration of the assembly process of the extension portion 18 or the like.

Further, although an example in which movement of the pair of weights 28 in the up-down direction can be attenuated by the closure member 24 has been explained in the present exemplary embodiment, the present disclosure is not limited thereto. Whether or not a configuration is provided such that movement of the pair of weights 28 in the up-down direction can be attenuated by the closure member 24 may be appropriately determined in consideration of vibration characteristics required of the extension portion 18.

Although an example in which the inner surfaces of the pair of weight arrangement recesses 20A that form the spaces in which the pair of weights 28 are respectively arranged are covered by the pair of recess inner covering portions 22A of the cushioning member 22 has been explained, the present disclosure is not limited thereto. In a case in which abnormal noise due to the pair of weights 28 contacting with the inner surfaces of the pair of weight arrangement recesses 20A is extremely small or the like, a configuration may be provided in which the cushioning member 22 is not provided. Further, a configuration can be provided in which cushioning members that cover outer surfaces of the weights 28 are provided in addition to the aforementioned cushioning member 22. Furthermore, it is also possible to provide a configuration in which the cushioning members that cover the outer surfaces of the weights 28 are provided without providing the aforementioned cushioning member 22.

Further, although an example in which the pair of weights 28 are provided has been explained in the present exemplary embodiment, the present disclosure is not limited thereto. For example, a configuration may be provided in which a single weight 28 is provided, or a configuration may be provided in which three or more weights 28 are provided.

Although exemplary embodiments of the present disclosure have been explained above, the present disclosure is not limited to that which is described above, and it is obvious that various modifications other than those described above can also be made to implement the present disclosure, within a range that does not depart from the spirit thereof.

What is claimed is:

1. A vehicle seat comprising:
a seat cushion main body portion that configures a portion of a seat cushion that supports buttocks of a seated occupant from a seat lower side;
an extension portion that configures another portion of the seat cushion and that is provided at a front end side of the seat cushion main body portion, a length of the seat cushion in a seat front-rear direction being adjusted due to the extension portion being displaced in the seat front-rear direction; and
a weight that is provided at an interior of the extension portion in a state of being relatively displaceable in an up-down direction with respect to the extension portion.

2. The vehicle seat according to claim 1, wherein at least one of an inner surface of a space in which the weight is provided at the extension portion or an outer surface of the weight is covered by a cushioning member that is capable of cushioning an impact.

3. The vehicle seat according to claim 1, wherein:
the extension portion is configured to include:
an extension portion main body having a weight arrangement recess that forms a space in which the weight is arranged and that is open at a seat lower side thereof, and
a closure member that closes an open end side of the weight arrangement recess in a state of being attached to a seat lower side of the extension portion main body; and
the closure member is formed using a member that is formed in a sheet shape and that is capable of deflection deformation in a thickness direction thereof.

4. The vehicle seat according to claim 3, wherein an opening through which the weight, which has been housed within the weight arrangement recess, is visible is formed at the closure member.
